(19) United States
(12) Patent Application Publication
(10) Pub. No.: US 2025/0322182 A1
(43) Pub. Date: Oct. 16, 2025

(54) METHOD AND DEVICE FOR IDENTIFICATION OF ACCESSORY, ELECTRONIC DEVICE AND NON-TRANSITORY COMPUTER-READABLE STORAGE MEDIUM

(71) Applicant: AAC ACOUSTIC TECHNOLOGIES (SHENZHEN) CO., LTD., Shenzhen (CN)

(72) Inventors: Hongyan Tao, Shenzhen (CN); Maoxi Qin, Shenzhen (CN)

(21) Appl. No.: 18/764,144

(22) Filed: Jul. 3, 2024

Related U.S. Application Data
(63) Continuation of application No. PCT/CN2024/086950, filed on Apr. 10, 2024.

(51) Int. Cl. G06K 7/10

(52) U.S. Cl. CPC G06K 7/10297

(57) ABSTRACT

Disclosed are a method and device for identification of accessory, an electronic device, and a non-transitory computer-readable storage medium. The method for identification of accessory includes: providing a host assembled with at least one accessory, where the host is provided with at least one detection element; obtaining status information of the at least one detection element, where each of the at least one accessory is provided with at least one trigger element, where the status information includes triggered and untriggered; determining arrangement of the at least one trigger element of the respective accessory according to the status information of each of the at least one detection element; and determining a type of the respective accessory according to the arrangement of the at least one trigger element. The method for identification of accessory achieves identification of type of accessory along with a reduced cost and occupied space.

### CROSS REFERENCE TO RELATED APPLICATIONS

The present application is a continuation of PCT Patent Application No. PCT/CN2024/086950, entitled “METHOD AND DEVICE FOR IDENTIFICATION OF ACCESSORY, ELECTRONIC DEVICE AND NON-TRANSITORY COMPUTER-READABLE STORAGE MEDIUM,” filed on Apr. 10, 2024, which is incorporated by reference herein in its entirety.

### TECHNICAL FIELD

Embodiments of the present disclosure relate to the field of electronic product accessories, and in particular, to a method and device for identification of accessory, an electronic device, and a non-transitory computer-readable storage medium.

### BACKGROUND

Automatic identification technology is one of the main contents of modern information technology. Information technology includes physical signal, electrical signal and sensor technologies. Automatic identification technology is widely used to identify the types of accessories assembled on the host of electronic products. Generally, different types of accessories can be assembled in specific areas of the host of an electronic product. After assembling the accessories, the host is required to detect the types of accessories to adjust the operation mode of the electronic product according to the types of accessories.

Generally, the current method for identification of accessory achieves identification of type of accessory along with a high cost and a large occupied space.

### SUMMARY

Embodiments of the present disclosure provide a method and device for identification of accessory, an electronic device, and a non-transitory computer-readable storage medium, which can achieve identification of type of accessory along with a reduced cost and occupied space.

According to some embodiments of the present disclosure, the embodiments of the present disclosure, on the one hand, provide a method for identification of accessory, comprising: providing a host, wherein the host is assembled with at least one accessory, and the host is provided with at least one detection element in a region close to a respective one of the at least one accessory; obtaining status information of the at least one detection element of the host, wherein each of the at least one accessory is provided with at least one trigger element, matching the at least one detection element, in a region close to the host, and a number of the at least one trigger element of the respective accessory is less than or equal to a number of the at least one detection element in a corresponding region of the host, wherein the status information includes triggered and untriggered, wherein the status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element; determining arrangement of the at least one trigger element of the respective accessory according to the status information of each of the at least one detection element of the host; and determining a type of the respective accessory assembled to the host according to the arrangement of the at least one trigger element of the respective accessory.

In some embodiments, the arrangement of the at least one trigger element involves a number and position of the at least one trigger element; determining the arrangement of the at least one trigger element of the respective accessory according to the status information of each of the at least one detection element of the host includes: determining the number and position of the at least one trigger element of the respective accessory according to a number and position of the respective detection element, in the at least one detection element, with the status information labeled as triggered.

In some embodiments, each of the at least one detection element includes a Hall sensor, and each of the at least one trigger element includes a magnet; obtaining the status information of the at least one detection element of the host includes: transmitting by the Hall sensor one of a high-level signal and a low-level signal and labeling the status information of the Hall sensor as triggered based on a fact that the Hall sensor detects a matched magnet in a corresponding position; and transmitting by the Hall sensor the other of the high-level signal and the low-level signal and labeling the status information of the Hall sensor as untriggered based on a fact that the Hall sensor does not detect the matched magnet in the corresponding position.

In some embodiments, determining the type of the respective accessory assembled to the host according to the arrangement of the at least one trigger element of the respective accessory includes: setting a mapping relationship, wherein the mapping relationship is used for representing a correspondence between one arrangement of the at least one trigger element and one type of the respective accessory; and determining the type of the respective accessory assembled to the host according to the arrangement of the at least one trigger element of the respective accessory and the mapping relationship.

In some embodiments, the at least one detection element corresponding to the respective accessory is uniformly distributed on a contact surface of the host for contacting the respective accessory.

In some embodiments, the at least one detection element is located inside the host and the at least one trigger element is located inside the respective accessory.

In some embodiments, the host has at least one detection circuit in one-to-one correspondence with the at least one detection element; and obtaining the status information of the at least one detection element of the host includes: obtaining, via each of the at least one detection circuit, the status information of a corresponding detection element in the at least one detection element of the host.

According to some embodiments of the present disclosure, the embodiments of the present disclosure, on the other hand, also provide a device for identification of accessory applicable to a host assembled with at least one accessory, where the host is provided with at least one detection element in a region close to a respective one of the at least one accessory. The device for identification of accessory comprises: an obtainer configured to obtain status information of the at least one detection element of the host, wherein each of the at least one accessory is provided with at least one trigger element, matching the at least one detection element, in a region close to the host, and a number of the at least one trigger element of the respective accessory is less than or equal to a number of the at least one detection element in a corresponding region of the host, wherein the status information includes triggered and untriggered, wherein the status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element; a determiner configured to determine arrangement of the at least one trigger element of the respective accessory according to the status information of each of the at least one detection element of the host; and an identifier configured to determine a type of the respective accessory assembled to the host according to the arrangement of the at least one trigger element of the respective accessory.

According to some embodiments of the present disclosure, the embodiments of the present disclosure, on the other hand, also provide an electronic device comprising: a memory, and a processor, where the memory is used for storing computer instructions executable on the processor, and the processor is used for executing the computer instructions to implement the method for identification of accessory as described in the above embodiments.

According to some embodiments of the present disclosure, the embodiments of the present disclosure, on the other hand, also provide a non-transitory computer-readable storage medium comprising: a computer program for implementing the method for identification of accessory as described in the above embodiments when executed.

The technical solution provided in the embodiments of the present disclosure has at least the following advantages.

In the method for identification of accessory provided by the embodiments of the present disclosure, firstly, a host is provided, the host is assembled with at least one accessory, and the host is provided with at least one detection element in a region close to a respective one of the at least one accessory. Status information of the at least one detection element of the host is obtained. Each of the at least one accessory is provided with at least one trigger element, matching the at least one detection element, in a region close to the host. A number of the at least one trigger element of a respective accessory of the at least one accessory is less than or equal to a number of the at least one detection element in a corresponding region of the host. The status information includes triggered and untriggered. The status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element. Arrangement of the at least one trigger element of the respective accessory is determined according to the status information of each of the at least one detection element of the host. A type of the respective accessory assembled to the host is determined according to the arrangement of the at least one trigger element of the respective accessory. In the relevant technology, the following two methods are generally used to identify the types of accessories assembled to the host. The first method is to set a camera or a scanning gun on the host, and set a quick response code or a bar code on the accessory, so the identification of the type of accessory can be achieved by the host scanning the code of the accessory. The second method is to set a Near Field Communication (NFC) card reader on the host, and set an NFC label on the accessory, so the identification of the types of accessories assembled to the host can be achieved by the NFC card reader on the host reading the NFC label on the accessory. However, if the first method of scanning code to identify accessory type is adopted, the camera or scanning gun on the host occupies a large volume, and has high requirements for system platform resources. Moreover, the quick response code or bar code on the accessory is easy to be copied and stolen. If the second method of identifying accessory type via NFC is adopted, both the host and the accessory need an antenna of certain volume, so the cost is high. Moreover, the card reader in long operating time consumes a lot of power, while intermittent activation of the car reader adversely affects user experience. The method for identification of accessory provided in the embodiments of the present disclosure provides another method applicable without code scanning or NFC card reading. At least one detection element is provided on the host, and at least one trigger element is provided on the accessory. The trigger elements on accessories of different types have different arrangements, so the types of accessories can be determined via different status information of detection elements on the host. In this way, it is possible to detect whether the host is assembled with accessories and the types of accessories assembled, where the cost is low, the hardware implementation is simple and the occupied volume is small. In addition, the more detection elements in a region of the host corresponding to one accessory, the more different combinations of status information generated by the detection elements, and the more types of accessories that can be identified. The number of detection elements corresponding to the respective accessory can be flexibly adjusted according to the number of types of accessories to be identified.

### BRIEF DESCRIPTION OF THE DRAWINGS

One or more embodiments are illustrated through the figures in the corresponding drawings. These exemplary illustrations do not constitute limitations on the embodiments unless otherwise stated. The figures in the accompanying drawings do not constitute a scale limitation. In order to illustrate the technical solutions in the embodiments of the present disclosure or in the conventional technology more clearly, the drawings used in the description of the embodiments are briefly described below. It is apparent that the drawings in the following description show only some embodiments of the present disclosure, and other drawings may be obtained by those of ordinary skill in the art based on these drawings without any creative efforts.

FIG. 1 is a flow chart of a method for identification of accessory according to an embodiment of the present disclosure;

FIG. 2 is a schematic diagram of a host equipped with accessories according to an embodiment of the present disclosure;

FIG. 3 is a schematic diagram of a device for identification of accessory according to an embodiment of the present disclosure; and

FIG. 4 is a schematic diagram of an electronic device according to an embodiment of the present disclosure.

### DETAILED DESCRIPTION OF THE EMBODIMENTS

It can be seen from the background technology that the current method for identification of accessory achieves identification of type of accessory along with a high cost and a large occupied space.

Embodiments of the present disclosure provide a method for identification of accessory, in which a host assembled with at least one accessory is first provided, and the host is provided with at least one detection element in a region close to a respective one of the at least one accessory. Status information of the at least one detection element of the host is obtained. Each of the at least one accessory is provided with at least one trigger element, matching the at least one detection element, in a region close to the host. A number of the at least one trigger element of a respective accessory of the at least one accessory is less than or equal to a number of the at least one detection element in a corresponding region of the host. The status information includes triggered and untriggered. The status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element. Arrangement of the at least one trigger element of the respective accessory is determined according to the status information of each of the at least one detection element of the host. A type of the respective accessory assembled to the host is determined according to the arrangement of the at least one trigger element of the respective accessory. In this way, it is possible to detect whether the host is assembled with accessories and the types of accessories assembled, where the cost is low, the hardware implementation is simple and the occupied volume is small. In addition, the more detection elements in a region of the host corresponding to one accessory, the more different combinations of status information generated by the detection elements, and the more types of accessories that can be identified. The number of detection elements corresponding to the respective accessory can be flexibly adjusted according to the number of types of accessories to be identified.

In order to make the object, technical solution and advantages of the embodiments of the present disclosure clearer, the following gives a detailed description of the embodiments of the present disclosure with reference to the accompanying drawings. However, those of ordinary skill in the art may understand that in the embodiments of the present disclosure, many technical details have been presented to facilitate a better understanding of the present disclosure by the reader. However, even without these technical details and the various variations and modifications based on the following embodiments, the technical solution claimed in the present disclosure can still be achieved.

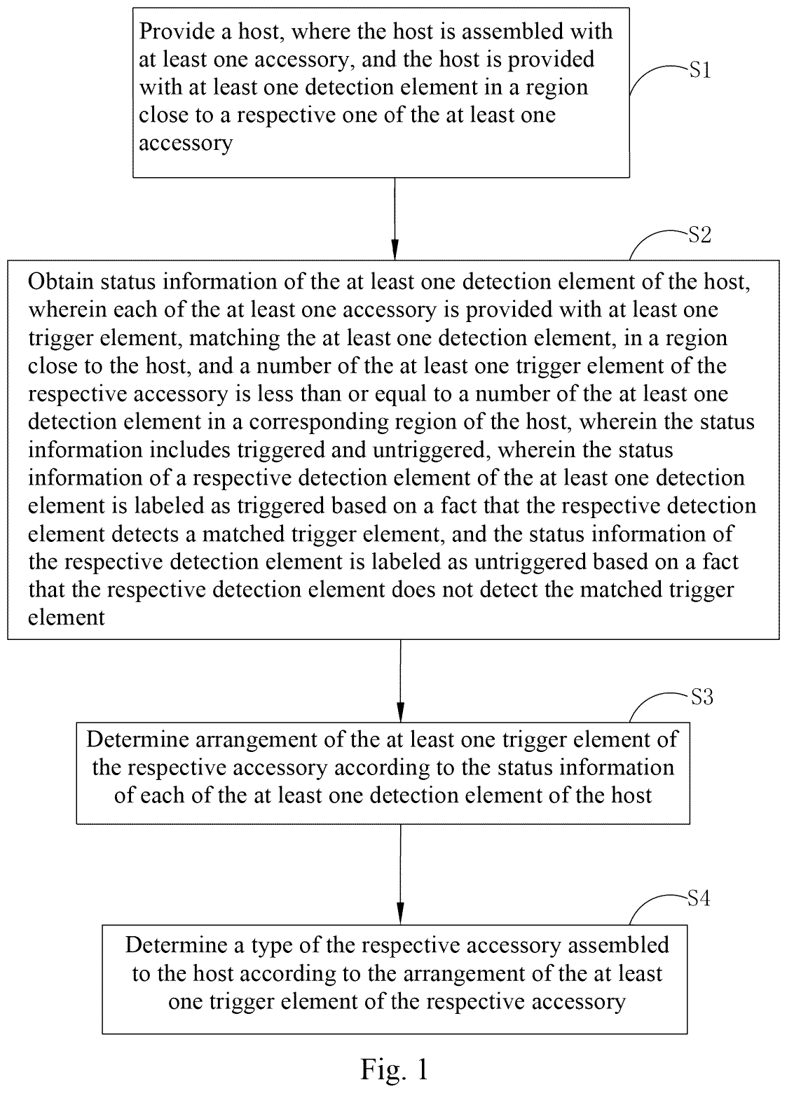

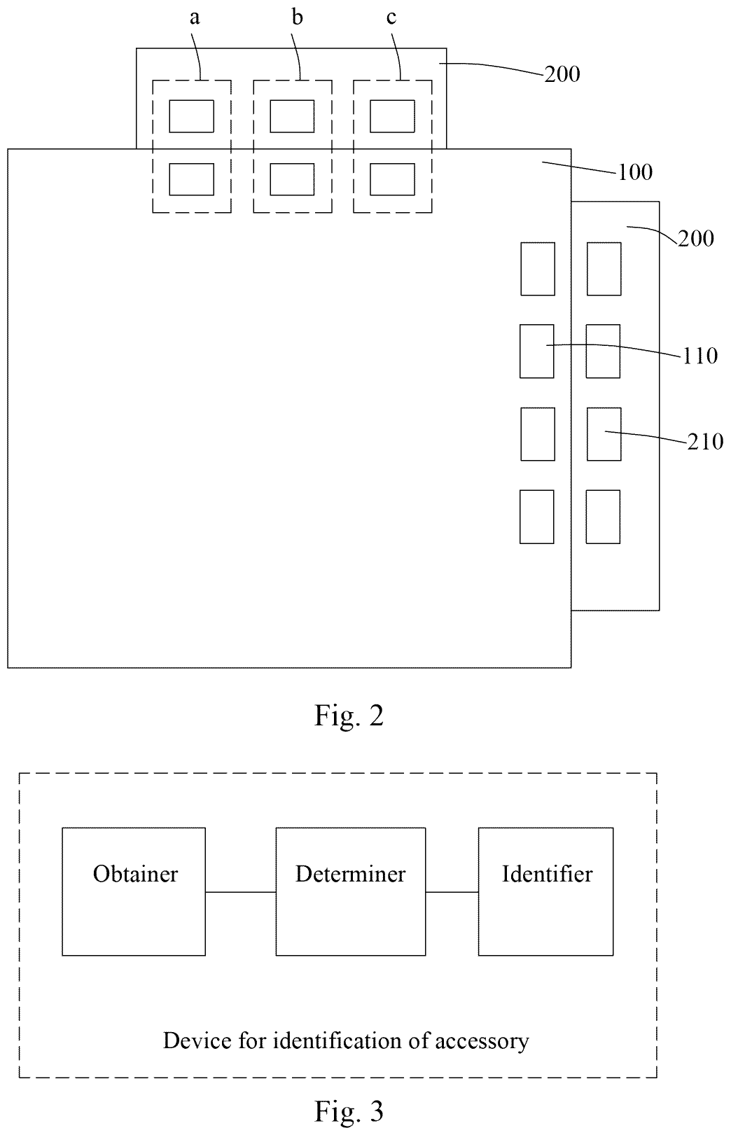

FIG. 1 is a flow chart of a method for identification of accessory according to an embodiment of the present disclosure. FIG. 2 is a schematic diagram of a host equipped with accessories according to an embodiment of the present disclosure.

With reference to FIGS. 1 and 2, in operation S1, a host 100 is provided, the host 100 is assembled with at least one accessory 200, and the host 100 is provided with at least one detection element 110 in a region close to a respective one of the at least one accessory 200.

The host 100 of an electronic product may have a region in which an accessory 200 can be assembled, and may be assembled with different types of accessories 200. Which types of accessories 200 are assembled on the host 100 can be identified with a certain method for identification of accessory, thereby enabling the host 100 to run under different operating states.

In some embodiments, the host 100 may have one or more regions for assembling with accessories 200, that is, the host 100 may be assembled with one or more accessories 200. The accessories 200 assembled to the host 100 may have different types. For example, in a case that the host is an electronic toy model, the electronic toy model may have regions for assembling with a hat and shoes. The hat and shoes may be accessories for the electronic toy model. Different types of hats and different types of shoes may be assembled. After the electronic toy model identifies the types of assembled hats and shoes, it may enter different operating states accordingly. The at least one detection element 110 arranged in the region of the host 100 close to a respective one of the at least one accessory 200 may be configured to identify a type of the respective accessory 200. The more types of the accessories 200 to be identified, the more detection elements 110 provided in this region.

With reference to FIGS. 1 and 2, in operation S2, status information of the at least one detection element 110 of the host 100 is obtained. Each of the at least one accessory 200 is provided with at least one trigger element 210, matching the at least one detection element 110, in a region close to the host 100. A number of the at least one trigger element 210 of a respective accessory 200 of the at least one accessory is less than or equal to a number of the at least one detection element 110 in a corresponding region of the host 100. The status information includes triggered and untriggered. The status information of a respective detection element 110 is labeled as triggered based on a fact that the respective detection element 110 detects a matched trigger element 210, and the status information of the respective detection element 110 is labeled as untriggered based on a fact that the respective detection element 110 does not detect the matched trigger element 210.

In other words, plural detection elements 110 may be provided on a region of the host 100 corresponding to one accessory 200. Assuming that the number of detection elements 110 in the region corresponding to one accessory 200 is n. The n detection elements 110 are arranged on the host 100, each of which has a corresponding position. The accessory 200 to be assembled at this region may have an integral number of trigger elements 210 less than or equal to n and greater than 0, for example, the number of trigger elements 210 on the accessory 200 may be n, n−1 . . . etc. A position of one of the plural trigger elements 210 on the accessory 200 needs to correspond to a certain detection element 110 on the host 100. If one trigger element 210 exists in a position of the accessory 200 corresponding to one detection element 110, this detection element 110 detects this matched trigger element 210, and the status information of this detection element 110 is labeled as triggered; and if no trigger element 210 exists in a position of the accessory 200 corresponding to one detection element 110, this detection element 110 cannot detect a matched trigger element 210, and the status information of this detection element 110 is labeled as untriggered.

Specifically, with reference to FIG. 2, three detection elements 110 are provided in a region of the host 100 corresponding to one accessory 200 assembled to an upper portion of the host 100, and the positions of the three detection elements 110 are designated as position a, position b and position c, respectively. Correspondingly, the number of trigger elements 210 that may be provided on the accessory 200 may be less than or equal to 3 and greater than 0, for example, the number of trigger elements 210 that may be provided on the accessory 200 may be 1, 2 or 3. In this case, the accessories 200 that can be assembled to the upper portion of the host 100 may have 7 types of arrangements. If the number of trigger elements 210 on the accessory 200 is one, the trigger element on the accessory 200 may be arranged as follows: the trigger element 200 being in position a, the trigger element 200 being in position b, and the trigger element 200 being in position c. If the number of trigger elements 210 on the accessory 200 is two, the trigger elements on the accessory 200 may be arranged as follows: the trigger elements 200 being in positions a and b, the trigger elements 200 being in position a and c, and the trigger elements 200 being in positions b and c. If the number of trigger elements 210 on the accessory 200 is three, the trigger elements on the accessory 200 may be arranged as follows: the trigger elements 200 being in positions a, b and c. That is, there are 7 types of arrangements in total. Correspondingly, the status information generated by the three detection elements 110 in this region also has 7 types: position a triggered, position b untriggered, and position c untriggered; position a untriggered, position b triggered, and position c untriggered; position a untriggered, position b untriggered, and position c triggered; position a triggered, position b triggered, and position c untriggered; position a triggered, position b untriggered, and position c triggered; position a untriggered, position b triggered, and position c triggered; position a triggered, position b triggered, and position c triggered. If any of the three detection elements 110 is untriggered, then no accessory is assembled in this region. In operation S1, it is required to obtain the status information of all the detection elements 110 to proceed with the next operation of accessory identification.

With reference further to FIG. 2, in some embodiments, each detection element 110 may include a Hall sensor, and each trigger element 210 may include a magnet. Obtaining the status information of the at least one detection element 110 of the host 100 includes: transmitting by the Hall sensor one of a high-level signal and a low-level signal and labeling the status information of the Hall sensor as triggered based on a fact that the Hall sensor detects a matched magnet in a corresponding position; and transmitting by the Hall sensor the other of the high-level signal and the low-level signal and labeling the status information of the Hall sensor as untriggered based on a fact that the Hall sensor does not detect the matched magnet in the corresponding position. For example, if the Hall sensor detects a magnet in a corresponding position, then it transmits a low-level signal, and if the Hall sensor does not detect a magnet in a corresponding position, then it transmits a high-level signal. Alternatively, if the Hall sensor detects a magnet in a corresponding position, then it transmits a high-level signal, and if the Hall sensor does not detect a magnet in a corresponding position, then it transmits a low-level signal. That is to say, whether a magnet exists in a position corresponding to the Hall sensor causes the Hall sensor to transmit two different signals. Detecting the signal transmitted by the Hall sensor can determine the status information of the Hall sensor as triggered or untriggered. In a case that each detection element 110 is a Hall sensor and each trigger element 210 is a magnet, the hardware implementation of the method for identification of accessory is simple and the overall cost thereof is low. Further, the Hall sensor and the magnet do not occupy a large volume, so that the cost and the space occupied by the detection element and the magnet can be reduced while achieving identification of accessory.

It should be noted that in a case that each detection element 110 is a Hall sensor and each trigger element 210 is a magnet, a certain distance shall be kept between adjacent Hall sensors to prevent mutual interference between adjacent Hall sensors and also between adjacent magnets, such mutual interference resulting in inaccurate identification results. The arrangement of keeping a certain distance improves the accuracy of the results of identification of accessory.

With reference to FIG. 2, in some embodiments, the at least one detection element 110 corresponding to the respective accessory 200 may be uniformly distributed on a contact surface of the host 100 for contacting the respective accessory 200. In a case that the at least one detection element 110 corresponding to the respective accessory 200 is uniformly distributed on a contact surface of the host 100 for contacting the respective accessory 200, a distance between adjacent detection elements 110 may be the same, or almost the same. In this way, the distance between any two detection elements 110 may be kept within a range that will not cause interference due to a too small distance and will not cause large occupied space due to a too large distance, which can avoid mutual interference between the detection elements 110, ensure the accuracy of the results of identification of accessory, and also reduce the space occupied by the detection elements 110 and the trigger elements 210.

With reference further to FIG. 2, in some embodiments, the detection elements 110 may be located inside the host 100, and the trigger elements 210 may be located inside the accessory 200. In a case that the detection elements 110 are located inside the host 100 and the trigger elements 210 are located inside the accessory 200, both the detection elements 110 and the trigger elements 210 are concealed, which can reduce the overall volume of the host 100 and the accessory 200, improve the aesthetics, and avoid information from being forged or stolen, and improve the safety.

In some other embodiments, the detection elements 110 may be located outside the host 100, and the trigger elements 210 may be located outside the accessory 200.

In some embodiments, the host 100 has plural detection circuits (not shown) in one-to-one correspondence with plural detection elements 110. Obtaining the status information of the at least one detection element 110 of the host 100 includes: obtaining, via each detection circuit, the status information of a corresponding detection element 110 of the host 100. In a case that the host 100 has plural detection circuits in one-to-one correspondence with plural detection elements 110, the status information of a respective detection element 110 of the host 100 can be obtained via a corresponding detection circuit. Since the status of each detection circuit varies according to whether the corresponding detection element 110 is triggered, the status of each detection circuit can be obtained, and the status information of the corresponding detection element 110 can be determined on the basis of the correspondence between the status of the respective detection circuit and whether the corresponding detection element 110 is triggered.

With reference to FIG. 1, in operation S3, the arrangement of the at least one trigger element 210 of the respective accessory 200 is determined according to the status information of each detection element 110 of the host 100.

In accordance with the above, with reference to FIG. 2, three detection elements 110 are provided in a region of the host 100 corresponding to the accessory 200 assembled to an upper portion of the host 100, and the positions of the three detection elements 110 are designated as position a, position b and position c, respectively. The status information of the three detection elements 110 includes 7 types: position a triggered, position b untriggered, and position c untriggered; position a untriggered, position b triggered, and position c untriggered; position a untriggered, position b untriggered, and position c triggered; position a triggered, position b triggered, and position c untriggered; position a triggered, position b untriggered, and position c triggered; position a untriggered, position b triggered, and position c triggered; position a triggered, position b triggered, and position c triggered. If any of the three detection elements 110 is untriggered, then no accessory 200 is assembled in this region. If the status information of one detection element 110 is labeled as triggered, it can be determined that there is one trigger element 210 on the accessory 200 at this position.

In some embodiments, the arrangement of the trigger elements 210 on the accessory 200 may only involve a number of the trigger elements. In such case determining the arrangement of the at least one trigger element 210 of the respective accessory 200 according to the status information of each of the at least one detection element 110 of the host 100 includes: determining the number of the at least one trigger element 210 on the respective accessory 200 according to a number of the respective detection element 110 with the status information labeled as triggered. Specifically, as shown in FIG. 2, three detection elements 110 are provided in a region of the host 100 corresponding to the accessory 200 assembled to the upper portion of the host 100. Correspondingly, three results of identification of accessory 200 can be obtained: the accessory 200 has one trigger element corresponding to that the status information of one detection element 110 is labeled as triggered; the accessory 200 has two trigger elements 210 corresponding to that the status information of two detection elements 110 is labeled as triggered; and the accessory 200 has three trigger elements 210 corresponding to that the status information of three detection elements 110 is labeled as triggered.

In some other embodiments, the arrangement of the trigger elements 210 on the accessory 200 may involve the number and position of the trigger elements. In such case determining the arrangement of the at least one trigger element 210 on the respective accessory 200 according to the status information of each of the at least one detection element 110 on the host 100 includes: determining the number and position of the at least one trigger element 210 on the respective accessory 200 according to a number and position of the respective detection element 110 with the status information labeled as triggered. Namely, the arrangement involves not only the number of trigger elements 210 on the accessory 200, but also involves the position of the trigger elements 210 on the accessory 200. Specifically, according to the above, in a case that three detection elements 110 are provided in a region of the host 100 corresponding to the accessory 200 assembled to the upper portion of the host 100, as shown in FIG. 2, there are seven combinations of the status information of the three detection elements 110, corresponding to seven arrangements of the trigger elements 210 on the accessory, specifically including: if the number of trigger elements 210 on the accessory 200 is one, the trigger element on the accessory 200 may be arranged as follows: the trigger element 200 being in position a, the trigger element 200 being in position b, and the trigger element 200 being in position c; if the number of trigger elements 210 on the accessory 200 is two, the trigger elements on the accessory 200 may be arranged as follows: the trigger elements 200 being in positions a and b, the trigger elements 200 being in position a and c, and the trigger elements 200 being in positions b and c; if the number of trigger elements 210 on the accessory 200 is three, the trigger elements on the accessory 200 may be arranged as such: the trigger elements 200 being in positions a, b and c. That is, there are 7 types of arrangements in total. Based on the status information of each detection element 110 on the host 100, it is possible to determine the arrangement of the trigger elements 210 on the accessory 200 is which one of the above 7 arrangements. If the arrangement involves the number and position, as many types of accessories 200 as possible can be identified with as few detection elements 110 and trigger elements 210 as possible, and multiple demands such as reducing the volume, reducing the cost, and identifying more types of accessories can be achieved at the same time, thereby effectively reducing the cost and improving the efficiency of accessory identification.

With reference to FIG. 1, in operation S4, a type of the accessory 200 assembled to the host 100 is determined according to the arrangement of the trigger elements 210 on the accessory 200.

In accordance with the above, after determining the arrangement of the trigger elements 210 on the accessory 200 according to the status information of each detection element 110 on the host 100, the type of the accessory 200 assembled to the host 100 can be determined according to the arrangement of the trigger elements 210 on the accessory 200. One type of arrangement of the trigger elements 210 on the accessory 200 may correspond to one type of accessory 200, so that the type of accessory 200 can be identified if the arrangement of the trigger elements 210 on the accessory 200 is known.

In some embodiments, determining the type of the accessory 200 assembled to the host 100 according to the arrangement of the trigger elements on the accessory 200 includes: setting a mapping relationship, where the mapping relationship is used for representing a correspondence between one arrangement of the trigger elements 210 and one type of the accessory; and determining the type of the accessory 200 assembled to the host 100 according to the arrangement of the trigger elements 210 on the accessory 200 and the mapping relationship. Specifically, with reference to FIG. 2, according to the above, in a case that three detection elements 110 are provided in a region of the host 100 corresponding to the accessory 200 assembled to the upper portion of the host 100, there are seven arrangements of the trigger elements 210 on the accessory 200, specifically including: if the number of trigger elements 210 on the accessory 200 is one, the trigger element on the accessory 200 may be arranged as follows: the trigger element 200 being in position a, the trigger element 200 being in position b, and the trigger element 200 being in position c; if the number of trigger elements 210 on the accessory 200 is two, the trigger elements on the accessory 200 may be arranged as follows: the trigger elements 200 being in positions a and b, the trigger elements 200 being in position a and c, and the trigger elements 200 being in positions b and c; if the number of trigger elements 210 on the accessory 200 is three, the trigger elements on the accessory 200 may be arranged as such: the trigger elements 200 being in positions a, b and c. The seven arrangements of the trigger elements 210 on the accessory 200 correspond to seven accessory types: the trigger element 210 being in position a corresponds to a first accessory type; the trigger element 210 being in position b corresponds to a second accessory type; the trigger element 210 being in position c corresponds to a third accessory type; the trigger elements 210 being in positions a and b corresponds to a fourth accessory type; the trigger elements 210 being in positions a and c corresponds to a fifth accessory type; the trigger elements 210 being in positions b and c corresponds to a sixth accessory type; the trigger elements 210 being in positions a, b and c corresponds to a seventh accessory type. Based on this one-to-one correspondence between the arrangement and the accessory type, a unique accessory type can be identified when the arrangement of the trigger elements 210 on the accessory 200 is known.

Refer to Table 1 in the following, Table 1 shows an accessory identification correspondence table in a case where each detection element is Hall sensor, each trigger element is magnet, if the Hall sensor detects a magnet in a corresponding position, then it transmits a high-level signal, and if the Hall sensor does not detect a magnet in a corresponding position, then it transmits a low-level signal, and the region of the host corresponding to this accessory has three detection elements. It should be noted that “0” in the column of identification results in Table 1 indicates that the status information of the detection element is untriggered, and no trigger element exists in the corresponding position; and “1” therein indicates that the status information of the detection element is triggered, and one trigger element exists in the corresponding position.

TABLE 1

| Numbering of | | | | Sensor | Sensor | Sensor | Identification |
|---|---|---|---|---|---|---|---|
| accessory | Position a | Position b | Position c | a | b | c | result |
| First | No | No | Yes | Low | Low | High | 001 |
| Second | No | Yes | No | Low | High | Low | 010 |
| Third | No | Yes | Yes | Low | High | High | 011 |
| Fourth | Yes | No | No | High | Low | Low | 100 |
| Fifth | Yes | No | Yes | High | Low | High | 101 |
| Sixth | Yes | Yes | No | High | High | Low | 110 |
| Seventh | Yes | Yes | Yes | High | High | High | 111 |
| No Accessory | No | No | No | Low | Low | Low | 000 |

Whether there are magnets at positions a, b and c is described in the three columns of position a, position b and position c in Table 1, and the three columns of sensor a, sensor b and sensor c indicate the types of signals transmitted by the Hall sensors at the three positions. The identification results indicate the arrangement of trigger elements on the accessory. The correspondence between the column of identification results and the column of accessory numbering is the mapping relationship between the arrangements and the accessory types. A unique identification result can correspond to one unique accessory type, so that the accessory type can be identified.

It should be noted that the above description of the arrangement of the detection elements 110 and the trigger elements 210, status information, mapping relationship and accessory type with reference to FIG. 2 is only an example, indicating a case where there are three detection elements 110 on the host corresponding to one accessory 200. In other embodiments, the region of the host 100 for assembling with one accessory 200 may be provided with n detection elements 110, where n is a positive integer greater than 0, and the specific value of n may be selected according to the number of types of the accessory 200.

Embodiments of the present disclosure provide a method for identification of accessory, in which a host assembled with at least one accessory is first provided, and the host is provided with at least one detection element in a region close to a respective one of the at least one accessory. Status information of the at least one detection element of the host is obtained. Each of the at least one accessory is provided with at least one trigger element, matching the at least one detection element, in a region close to the host. A number of the at least one trigger element of a respective accessory of the at least one accessory is less than or equal to a number of the at least one detection element in a corresponding region of the host. The status information includes triggered and untriggered. The status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element. Arrangement of the at least one trigger element of the respective accessory is determined according to the status information of each of the at least one detection element of the host. A type of the respective accessory assembled to the host is determined according to the arrangement of the at least one trigger element of the respective accessory. In this way, it is possible to detect whether the host is assembled with accessories and the types of accessories assembled, where the cost is low, the hardware implementation is simple and the occupied volume is small. In addition, the more detection elements in a region of the host corresponding to one accessory, the more different combinations of status information generated by the detection elements, and the more types of accessories that can be identified. The number of detection elements corresponding to the respective accessory can be flexibly adjusted according to the number of types of accessories to be identified.

Correspondingly, another embodiment of the present disclosure also provides a device for identification of accessory used for implementing the method for identification of accessory provided in the above embodiments. The following provides a detailed description of the device for identification of accessory provided in another embodiment of the present disclosure in conjunction with the accompanying drawings. For parts that are identical or corresponding to those in the previous embodiments, reference may be made to the corresponding descriptions of the aforementioned embodiments, and further elaboration will not be provided here.

FIG. 3 is a schematic diagram of a device for identification of accessory according to an embodiment of the present disclosure.

With reference to FIG. 3, the device for identification of accessory is applied to a host assembled with at least one accessory, and the host is provided with at least one detection element in a region close to a respective one of the at least one accessory. The device for identification of accessory comprises: an obtainer 310 configured to obtain status information of the at least one detection element of the host, where each of the at least one accessory is provided with at least one trigger element, matching the at least one detection element, in a region close to the host, and a number of the at least one trigger element of the respective accessory is less than or equal to a number of the at least one detection element in a corresponding region of the host, where the status information includes triggered and untriggered; the status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element; a determiner 320 configured to determine arrangement of the at least one trigger element of the respective accessory according to the status information of each of the at least one detection element of the host; and an identifier 330 configured to determine a type of the respective accessory assembled to the host according to the arrangement of the at least one trigger element of the respective accessory.

Correspondingly, another embodiment of the present disclosure also provides an electronic device used for implementing the method for identification of accessory provided in the above embodiments. The following provides a detailed description of the electronic device provided in another embodiment of the present disclosure in conjunction with the accompanying drawings. For parts that are identical or corresponding to those in the previous embodiments, reference may be made to the corresponding descriptions of the aforementioned embodiments, and further elaboration will not be provided here.

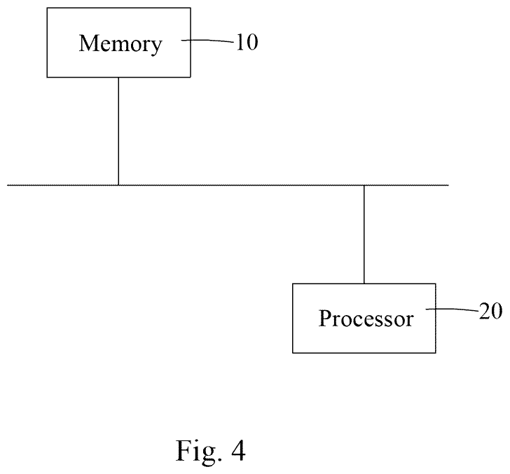

FIG. 4 is a schematic diagram of an electronic device according to an embodiment of the present disclosure.

With reference to FIG. 4, the electronic device provided in embodiments of the present disclosure comprises: a memory 10, and a processor 20, where the memory 10 is used for storing computer instructions executable on the processor 20, and the processor 20 is used for executing the computer instructions to implement the method for identification of accessory as described in the above embodiments.

The memory 10 and the processor 20 are connected via a bus. The bus may include any number of interconnected buses and bridges. The bus connects one or more processors 20 and various circuits of the memory 10. The bus can also connect peripheral devices, voltage regulators, and various other circuits such as power management circuits, which are known in the art and therefore will not be further described herein. A bus interface provides an interface between the bus and a transceiver. The transceiver may be one element or multiple elements, such as plural receivers and transmitters, for providing units for communicating with various other devices over a transmission medium. Data processed by the processor is transmitted over a wireless medium via an antenna. Further, the antenna is configured to receive data and transmit the data to the processor 20.

The processor 20 is responsible for managing the bus and general processes and may also provide various functions, including timing, peripheral interfaces, voltage regulation, power management, and other control functions. The memory 10 may be used to store data used by the processor 20 in performing an operation.

Correspondingly, another embodiment of the present disclosure also provides a non-transitory computer-readable storage medium used for implementing the method for identification of accessory provided in the above embodiments. The following provides a detailed description of the non-transitory computer-readable storage medium provided in another embodiment of the present disclosure in conjunction with the accompanying drawings. For parts that are identical or corresponding to those in the previous embodiments, reference may be made to the corresponding descriptions of the aforementioned embodiments, and further elaboration will not be provided here.

A computer program is stored on the non-transitory computer-readable storage medium provided in an embodiment of the present disclosure, where the computer program is used for implementing the method for identification of accessory provided in the above embodiments when executed.

That is, a person skilled in the art can understand that all or part of the operations in the method of the above embodiments can be implemented by instructing relevant hardware by a program stored in a storage medium. The program includes instructions for enabling a device (such as a microcontroller, chip, etc.) or a processor to perform all or part of the operations of the method as described in the above embodiments of the present disclosure. The storage medium includes: USB flash disk, removable hard disk, read-only memory (ROM), random access memory (RAM), disk or compact disk, and other media that can store program codes.

Those of ordinary skill in the art can understand that the aforementioned embodiments are specific examples for implementing the present disclosure. In practical applications, various modifications can be made to them in form and detail without deviating from the spirit and scope of the present disclosure. A person skilled in the art may make various alterations and modifications without departing from the spirit and scope of the present disclosure, and thus the scope of protection of the present disclosure should be determined by the scope of the appended claims.

1. A method for identification of accessory, comprising:
providing a host, wherein the host is assembled with at least one accessory, and the host is provided with at least one detection element in a region close to a respective one of the at least one accessory;
obtaining status information of the at least one detection element of the host, wherein each of the at least one accessory is provided with at least one trigger element, matching the at least one detection element, in a region close to the host, and a number of the at least one trigger element of the respective accessory is less than or equal to a number of the at least one detection element in a corresponding region of the host, wherein the status information includes triggered and untriggered, wherein the status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element;
determining arrangement of the at least one trigger element of the respective accessory according to the status information of each of the at least one detection element of the host; and
determining a type of the respective accessory assembled to the host according to the arrangement of the at least one trigger element of the respective accessory,
wherein the arrangement of the at least one trigger element involves a number and position of the at least one trigger element;
determining the arrangement of the at least one trigger element of the respective accessory according to the status information of each of the at least one detection element of the host includes:
determining the number and position of the at least one trigger element of the respective accessory according to a number and position of the respective detection element, in the at least one detection element, with the status information labeled as triggered;
wherein each of the at least one detection element includes a Hall sensor, and each of the at least one trigger element includes a magnet;
obtaining the status information of the at least one detection element of the host includes:
transmitting by the Hall sensor one of a high-level signal and a low-level signal and labeling the status information of the Hall sensor as triggered based on a fact that the Hall sensor detects a matched magnet in a corresponding position; and
transmitting by the Hall sensor the other of the high-level signal and the low-level signal and labeling the status information of the Hall sensor as untriggered based on a fact that the Hall sensor does not detect the matched magnet in the corresponding position;
wherein determining the type of the respective accessory assembled to the host according to the arrangement of the at least one trigger element of the respective accessory includes:
setting a mapping relationship, wherein the mapping relationship is used for representing a correspondence between one arrangement of the at least one trigger element and one type of the respective accessory; and
determining the type of the respective accessory assembled to the host according to the arrangement of the at least one trigger element of the respective accessory and the mapping relationship.

2. (canceled)

3. (canceled)

4. (canceled)

5. The method for identification of accessory according to claim 1, wherein the at least one detection element corresponding to the respective accessory is uniformly distributed on a contact surface of the host for contacting the respective accessory.

6. The method for identification of accessory according to claim 1, wherein the at least one detection element is located inside the host and the at least one trigger element is located inside the respective accessory.

7. The method for identification of accessory according to claim 5, wherein the at least one detection element is located inside the host and the at least one trigger element is located inside the respective accessory.

8. The method for identification of accessory according to claim 1, wherein the host has at least one detection circuit in one-to-one correspondence with the at least one detection element; and
obtaining the status information of the at least one detection element of the host includes:
obtaining, via each of the at least one detection circuit, the status information of a corresponding detection element in the at least one detection element of the host.

9. A device for identification of accessory, applied to a host assembled with at least one accessory, and the host being provided with at least one detection element in a region close to a respective one of the at least one accessory, the device for identification of accessory comprising:
an obtainer configured to obtain status information of the at least one detection element of the host, wherein each of the at least one accessory is provided with at least one trigger element, matching the at least one detection element, in a region close to the host, and a number of the at least one trigger element of the respective accessory is less than or equal to a number of the at least one detection element in a corresponding region of the host, wherein the status information includes triggered and untriggered, wherein the status information of a respective detection element of the at least one detection element is labeled as triggered based on a fact that the respective detection element detects a matched trigger element, and the status information of the respective detection element is labeled as untriggered based on a fact that the respective detection element does not detect the matched trigger element, each of the at least one detection element includes a Hall sensor, and each of the at least one trigger element includes a magnet;
a determiner configured to determine arrangement of the at least one trigger element of the respective accessory according to the status information of each of the at least one detection element of the host, the arrangement of the at least one trigger element involves a number and position of the at least one trigger element; and
an identifier configured to determine a type of the respective accessory assembled to the host according to the arrangement of the at least one trigger element of the respective accessory.

10. An electronic device, comprising: a memory, and a processor, wherein the memory is used for storing computer instructions executable on the processor, and the processor is used for executing the computer instructions to implement the method for identification of accessory according to claim 1.

11. A non-transitory computer-readable storage medium storing a computer program, wherein the computer program is executable to implement the method for identification of accessory according to claim 1.
